(19) United States
(12) Patent Application Publication
(10) Pub. No.: US 2025/0249393 A1
(43) Pub. Date: Aug. 7, 2025

(54) METHOD AND SYSTEM FOR CO2 CAPTURE AND UTILIZATION

(71) Applicant: Hans Gude GUDESEN, Gamle Fredrikstad (NO)

(72) Inventors: Hans Gude GUDESEN, Luzern (CH); Per-Erik NORDAL, Asker (NO); Are LUND, Melhus (NO); Kai W. HJARBO, Trondheim (NO); John C. MORUD, Trondheim (NO)

(73) Assignee: Hans Gude GUDESEN, Gamle Fredrikstad (NO)

(21) Appl. No.: 18/855,085

(22) PCT Filed: Apr. 4, 2023
(86) PCT No.: PCT/NO2023/050078

§ 371 Date: Oct. 8, 2024

(30) Foreign Application Priority Data
Apr. 8, 2022 (NO) 20220426

(51) Int. Cl. B01D 53/14; B01D 53/047

(52) U.S. Cl. CPC B01D 53/1475; B01D 53/047; B01D 53/145; B01D 2257/504; B01D 2258/0283; B01D 2259/40003; B01D 2259/40028

(57) ABSTRACT

A method for capturing CO₂ from a gas mixture by dissolution in water is disclosed. The method comprises injecting the gas mixture as bubbles into a volume of water, allowing CO₂ enriched water to exit out of the volume, and performing a depressurizing process of the CO₂ enriched water. A corresponding system is also disclosed.

### FIELD OF THE INVENTION

The present invention generally relates to a method for selectively separating CO₂ gas from a mixture of gases, and systems for carrying out the method. It also includes methods and systems for recovering the CO₂ that has been separated from the other gases.

### BACKGROUND OF THE INVENTION

Emissions of CO₂ into the atmosphere from human activities are generally acknowledged as a major unsolved problem both locally where concentrations of CO₂ may become high and cause acute damage to flora and fauna, and on a global scale where the background concentration of CO₂ in the air is steadily rising, causing global warming and destruction of marine habitats. Furthermore, separating CO₂ gas from a mixture of gases is of extreme importance in many industries, e.g. the transport and use of oil and natural gas and reforming processes involving synthesis of hydrogen from gas or oil.

To meet these challenges, great efforts have been spent worldwide to capture and dispose of CO₂, in particular from high volume point emitters such as fossil fueled power plants, cement factories and garbage incinerators. Several methods are under development for capture of CO₂ from flue or synthesis gases, employing chemical adsorption, membrane systems and solid adsorbents. These systems are environmentally challenging (chemical adsorption) and/or energy or process demanding. A prominent example is the amine process where CO₂ is separated from flue gases (see, e.g.: https://ccsnorway.com/capture-studies/) which is very energy consuming, expensive, and may employ toxic chemicals.

There is thus a pressing need to develop new clean, low cost, high capacity solutions that are capable of extracting CO₂ from relevant gas mixtures in an environmentally and energy friendly manner.

### SUMMARY OF THE INVENTION

A first aspect of the invention is a method for capturing CO₂ from a gas mixture comprising CO₂ and one or more other gases by dissolution in a liquid water phase, where the CO₂ gas has higher solubility in the water than the one or more other gases, where the method comprises the following steps:
injecting the gas mixture as bubbles into a volume of water with a surface, allowing the gas mixture in the bubbles to interact with the water, thereby causing CO₂ gas to dissolve in the water to a higher degree than the one or more other gases, further allowing the bubbles enriched in gas not dissolved to ascend to and exit from the surface of the volume of water, resulting in the water becoming enriched in CO₂, and further allowing the CO₂ enriched water to exit out of the volume; and
performing a first step depressurizing of the CO₂ enriched water to a first pressure level thereby degassing the one or more other gases from the CO₂ enriched water to a higher degree than CO₂ giving first step depressurized water.

Optionally, the method further comprises performing a second step depressurizing of the first step depressurized water where depressurizing is to a lower pressure level than that in the first step depressurizing, thereby degassing CO₂ from the first step depressurized water giving second step depressurized water depleted in CO₂.

Optionally, depressurizing is by one or more of the following: A throttling process, flashing over a valve/choke, or pumping by a vacuuming device.

Optionally, the method comprises collecting the CO₂ degassed from the water in the second step depressurizing.

Optionally, prior to the injecting, the method comprises at least one of i) compressing the gas mixture preferably to a minimum pressure of 3 bara and ii) cooling the gas mixture preferably to 5-30 degrees C.

Optionally, water in the water volume is counter current to the bubbles, with a water descent rate preferably lower than ascent rate of the bubbles.

Optionally, the method comprises obtaining pressure of the liquid water phase in the volume of water by at least one of the following: A static head h₁ in the volume of water and: Gas pressure acting on the surface of the volume of water.

Optionally, the method comprises using gas under pressure from pipe system (40) in compressor (31) for compression of incoming gas (30) and (11).

Optionally, the method comprises, in a batch mode, filling the water volume with water prior to the step of injecting, keeping the water stagnant for a period when CO₂ is dissolved, and thereafter completing the step by allowing the CO₂ enriched water to exit out of the volume.

Optionally, gas degassed from the water in the first step depressurizing is reinjected in the gas mixture prior to the injecting and, if applicable, the compressing mentioned above.

Optionally, the method comprises cooling gas and vapour degassed from the water in the second step depressurizing giving condensed water and gas enriched in CO₂.

Optionally, the method comprises reinjecting the condensed water into the first step depressurized water prior to the second step depressurizing.

Optionally, the method comprises releasing the gas enriched in CO₂ to any further treatment.

Optionally, the method comprises injecting the second step depressurized water depleted in CO₂ into the water volume.

Optionally, the method comprises injecting water into the water volume.

Optionally, the method uses at least one following water volume, and where the method further comprises performing the step of injecting on each following volume by injecting at least part of the gas exiting from the ascending bubbles of the preceding volume, and where the CO₂ enriched water exiting from the following volume is injected in the preceding volume.

Optionally, the gas mixture comprises at least one of flue gas, natural gas and synthetic gas.

Optionally, the method comprises diverting at least parts of the first step depressurized water thereby producing carbonated water.

Another aspect of the invention is a system for capturing CO₂ from a gas mixture comprising CO₂ and one or more other gases by dissolution in a liquid water phase, where the CO₂ gas has higher solubility in the water than the one or more other gases, where the system is arranged for performing the method described above.

Another aspect of the invention is a system for capturing CO₂ from a gas mixture comprising CO₂ and one or more other gases by dissolution in a liquid water phase, where the CO₂ gas has higher solubility in the water than the one or more other gases, where the system comprises:
means for injecting the gas mixture as bubbles into a volume of water with a surface, allowing the gas mixture in the bubbles to interact with the water, thereby causing CO₂ gas to dissolve in the water to a higher degree than the one or more other gases, further allowing the bubbles enriched in gas not dissolved to ascend to and exit from the surface of the volume of water, resulting in the water becoming enriched in CO₂, and further allowing the CO₂ enriched water to exit out of the volume; and
means for performing a first step depressurizing of the CO₂ enriched water to a first pressure level thereby degassing the one or more other gases from the CO₂ enriched water to a higher degree than CO₂ giving first step depressurized water.

Optionally, the system comprises means for performing a second step depressurizing of the first step enriched water where depressurizing is to a lower pressure level than that in the first step depressurizing, thereby degassing CO₂ from the first step depressurized water giving second step depressurized water depleted in CO₂.

### DESCRIPTION OF THE FIGURES

The above and further features of the invention are set forth with particularity in the appended claims and together with advantages thereof will become clearer from consideration of exemplary embodiments of the invention given with reference to the accompanying drawings.

Embodiments of the present invention will now be described, by way of example only, with reference to the following figures, wherein:

FIG. 1 shows a first preferred embodiment of the present invention.

FIG. 2 shows a second preferred embodiment of the present invention

FIG. 3 shows a third preferred embodiment of the present invention.

FIG. 4 shows a fourth preferred embodiment of the present invention

### LIST OF REFERENCE NUMBERS IN THE FIGURES

The following reference numbers refer to the drawings:

### Number Designation

1. Flue gas entry
2. Compressor
3. Tank
4. Mixer
5. Pipe system
6. First depressurizing unit
7. Chimney
8. Pipe system
9. Pipe system
10. Pipe system
11. Pipe system
12. Second depressurizing unit
13. Pipe system
14. Pipe system
15. Heat exchanger
16. Pipe system
17. Liquid pump
18. Valve or choke
19. Pipe system
20. Liquid pump
21. Vacuum pump/compressor
22. Gas/liquid separator
23. Pipe system
24. Pipe system
25. Pipe system
26. Liquid pump
27. Pipe system
28. Pipe system
29. Pipe system
30. Flue/synthetic gas
31. Compressor
32. Compressor
33. Pipe system
34. Mixer
35. Tank
36. Tank
37. Tank
38. Pipe system
39. Pipe system
40. Pipe system
41. Valve
42. Liquid pump
43. Pipe system
44. Liquid pump
45. Pipe system
46. Pipe system
47. Valve or choke
48. Pipe system
49. Pipe system
50. Valve
51. Valve or choke
52. Pipe system
53. Stream
h1 Static head
h2 Static head
h3 Static head
h4 Static head
h5 Static head

### DESCRIPTION OF PREFERRED EMBODIMENTS OF THE INVENTION

The present invention may be used for capture of CO₂ from an input gas containing CO₂ in a mixture with other gases, e.g. flue or synthetic gas. The input gas may be of any composition and state, but preferentially with a temperature between 0 and 30° C. Flue gas may also preferentially be free of sour gasses as e.g., NOₓ, SO₂, HCl and HF, and environmentally unfriendly components as e.g. Hg. This may be obtained by any suitable method for pre-treatment of flue gas if needed.

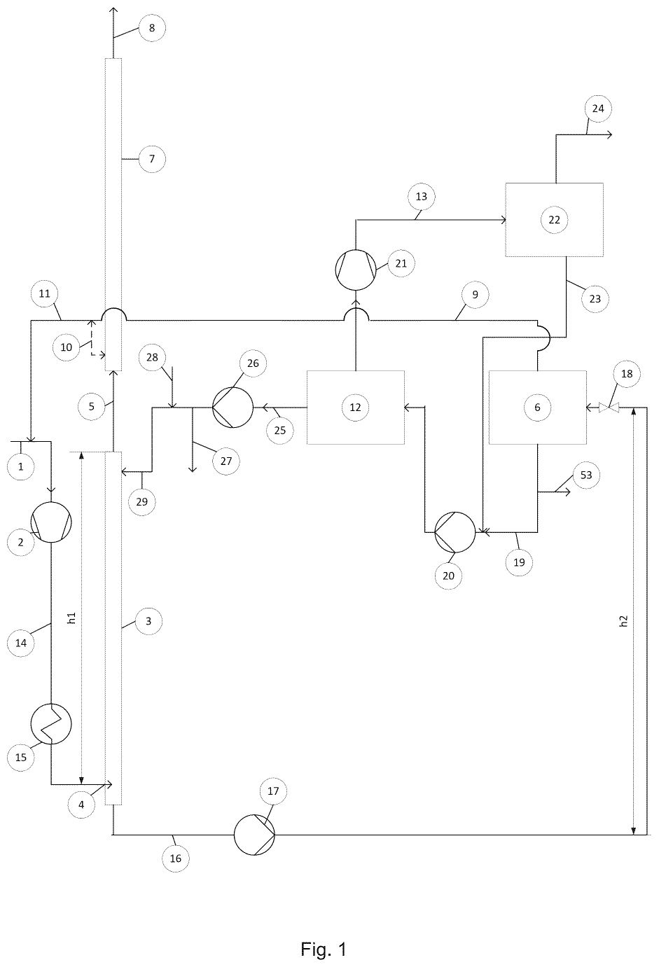

The basic principles of the present invention can be understood by inspection of FIG. 1: Flue gas (1) is compressed by a compressor (2) before being injected into a liquid water phase in a tank (3) as compressed gas by a mixer (4). The gas phase is then contacted with the water phase in the tank (3) where CO₂ is dissolved in the water phase together with other flue gas constituents, e.g. nitrogen and some oxygen. The amount of gas dissolved in the water phase will mainly depend on pressure, temperature and pH. The injected gas forms bubbles that float upwards in the column against downward flowing water. The constituent gases in the flue gas interact with the water: The gas transport out of the bubbles and into the water will differ between the gas species, reflecting differences in diffusivity and solubility in the water surrounding the bubble. This results in segregation of gas species where CO₂ which has the highest diffusivity and solubility is more easily transported into the water outside the bubble, while a larger proportion of the other gas species (e.g. N₂) remain inside the bubble and are transported out of the water volume when the bubble floats to the surface. Thus, a high degree of gas separation can be achieved by collecting the water with dissolved high solubility gas on the one hand and allowing the bubbles with the low solubility gas species to escape from the surface on the other hand. Excess gas is depleted from the tank (3) via a pipe system (5). The water phase in the tank (3) is transported via the pipe system (16) and degassed in the first depressurizing unit (6) where some of the CO₂ and other gases is released to a pipe system (9). Gas stream in pipe system (9) may be depleted via a pipe system (10) to a chimney (7) or injected via a pipe system (11) back to the flue gas entry (1). Water phase from the first depressurizing unit (6) is then degassed in the second depressurizing unit (12), where a CO₂ rich gas is obtained and transported via a pipe system (13). Water phase from the second depressurizing unit (12) is depleted or re-injected back to the tank (3).

A first preferred embodiment of the invention shall now be described in detail with reference to FIG. 1:

Flue gas entering the system at the flue gas entry (1) may be at pressure above atmospheric or if needed compressed to a given pressure e.g. 3 bara in the pipe system (14) by a compressor (2). Compressor (2) may be of any suitable type powered by any suitable means (e.g. electric, steam, high pressure gas). Pipe system (14) may be of any pipe diameter, pressure rate and material and may contain any valve, fan, cooler, heat exchanger, or any other item suitable for the process. Flue gas (1) may be compressed to any suitable pressure for the invention, put preferably to a minimum pressure of 3 bara. Before entering the tank (3), flue gas in pipe system (14) may be cooled to a temperature suited for the process (e.g. 5 to 30° C. for a flue gas) in a cooler (15). Cooler (15) may be any kind of cooler or heat exchanger.

Compressed flue gas in (14) is injected into a liquid water phase in the tank (3) by any suitable means at mixer (4). Mixer (4) may be of any kind, distributing gas from (14) as small bubbles into the water phase in the tank (3). At the injection point (4), the compressed flue gas (14) will be at a higher pressure than the water phase in the tank (3). Pressure of water phase in the tank (3) at injection point (4) may be obtained, but not restricted to, by a static head h₁. The water phase may be from fresh or salt water. If any conditioning of the water phase is needed, any environmentally friendly inhibitor or conditioning chemical may be added to the water phase, e.g. for inhibition of any scale formation from e.g. salt water. The tank (3) may be a vertical pipe or tank of any suitable diameter or height, made from any suitable material. Flue gas from mixing point (4) will rise in the water phase in the tank (3) due to buoyancy, leaving the tank (3) into pipe system (5). Water phase in the tank (3) may be stagnant (batch mode) or preferentially, counter current to the gas phase from the pipe system (14). If counter current, the fluid flow rate of water in the tank (3) should preferentially be lower than gas flow ascending rate in the tank (3). The tank (3) may be open or filled with any suitable means (e.g. mesh, any gas/water mixer, or any suitable gas/water contactor for optimum contact area between water and flue gas).

In the tank (3) CO₂ from flue gas (1) will be dissolved in the water phase. Other gases in the flue gas as e.g. nitrogen and some oxygen will also to some lesser degree be dissolved in the water phase. The amount of CO₂ dissolved in the water phase in the tank (3) is mainly given by pressure, temperature, pH in the water phase, and the ratio between water and gas in the tank (3). Given right conditions in the tank (3), up to nearly 100% of CO₂ in the flue gas (1) may be dissolved in the water phase in the tank (3).

Flue gas in the tank (3) not dissolved in the water phase in the tank (3) enters the pipe system (5), which may be, e.g., a chimney (7) of any kind for releasing the gas to the atmosphere, or to a pipe system (8) for any after treatment or use of the gas. Pipe systems (5) and (8) and chimney (7) may be of any pipe diameter, pressure rate and material and may contain any valve, choke, or any other item suitable for the process.

Water enriched in CO₂ from the tank (3) goes through pipe system (16) to be depressurized in unit (6). Pipe system (16) may include a pump (17). Pump (17) may be of any kind, suitable for the purpose. Water phase from the tank (3) may also go through pipe system (16) to the first depressurizing unit (6) via static head h₂ if h₂ is less than static head h₁ in the tank (3). If pipe system (16) includes a static head h₂, gas dissolved in the water phase may start to form bubbles in the water phase due to decreased pressure when rising. Pipe system (16) will then be a part of first depressurizing unit (6). Pipe system (16) may be of any pipe diameter, pressure rate and material and may contain any valve, choke, heat exchanger or any other item suitable for the process.

The first depressurizing unit (6) may be a tank or pipe system or any other suitable unit, where the water phase from pipe system (16) is introduced through a choke or valve (18). The valve (18) may be any valve or choke suitable for the purpose. Pressure difference across the valve (18) may be zero or any higher pressure suitable for the process. The first depressurizing unit (6) may include any interior for an efficient gas/water separation. Pressure inside the first depressurizing unit (6) may be atmospheric or any higher pressure suitable for the process.

Water phase from the first depressurizing unit (6), carrying dissolved CO₂, goes through pipe system (19) to vacuum/reduced pressure chamber (12). Pipe system (19) may include a pump (20) of any kind suitable for the process. (20) may also by a valve or choke of any kind. Pipe system (19) may be of any pipe diameter, pressure rate and material and may contain any valve, cooler, heat exchanger, or any other item suitable for the process.

As indicated in FIG. 1, water from the first depressurizing unit (6), carrying dissolved CO₂, may optionally be partly diverted (53) from the flow in the pipe system (19) for direct use in a wide range of applications (cf. below).

The second depressurizing unit (12) may be any tank or pipe system suitable for the purpose. In (12) vacuum/reduced pressure will de-gas the water phase, i.e. draw out gas dissolved in the water phase (mainly CO₂) together with some water vapour into the gas phase, by a vacuum/reducing pressure pump, compressor or by any other suitable means (21), and pipe system (13). Pipe system (13), before and after (21) may be of any pipe diameter, pressure rate and material and may contain any valve, heat exchanger, or other item suitable for the process.

Gas and vapour from pipe system (13) may be pressurized and/or cooled in (22), which may be any tank or pipe system suitable for the purpose. Condensed water from (22) may be reinjected by pipe system (23) into pipe system (19), before or after (20). Pipe system (23) may be of any pipe diameter, pressure rate and material and may contain any valve, pump, heat exchanger, cooler and/or any other item suitable for the process.

CO₂ rich gas from (22) is released through pipe system (24) to any further treatment (e.g. before being purified and transported to a permanent storage) or any other use.

Water from (12), depleted of most dissolved gases, goes through pipe system (25), before and after the liquid pump (26), to the top (29) of the tank (3). The liquid pump (26) is a pump of any suitable kind. Pipe system (25) may be of any pipe diameter, pressure rate and material and may contain any valve, cooler, heat exchanger, or any other item suitable for the process. Some water may have to bleed out of the process via the pipe system (27) if any unwanted components are increased in the water phase from flue gas (1). Fresh water will then be added to the process via pipe system (28). If needed, water from (27) will be cleaned by any suitable means before further disposal. In some applications water phase may be used “once through” in the process. All water will then be injected at (28) and depleted at (27). Water at (28) may be fresh or salt water and at a temperature suitable for the process.

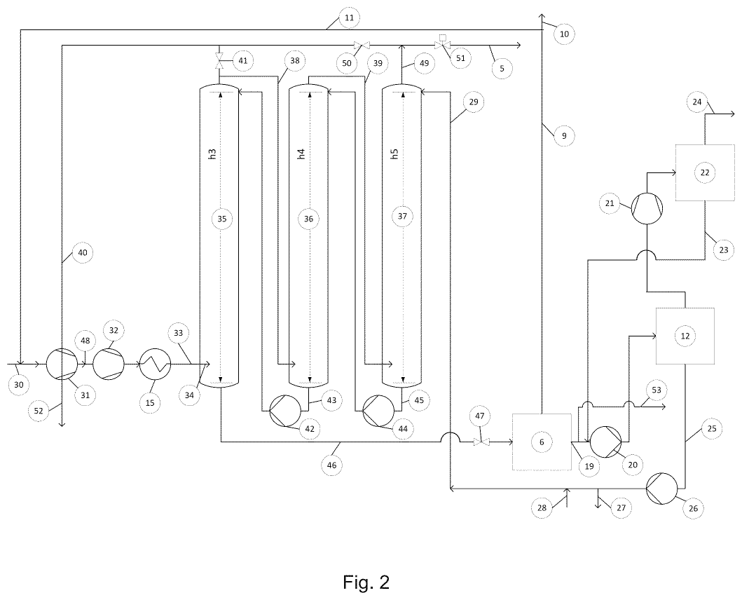

A second preferred embodiment of the invention is given in FIG. 2. The application may be used for capture of CO₂ from any flue or synthetic gas containing CO₂, or from any other suitable gas phase containing CO₂. The invention may also be used for capture of any other gas from a gas phase suitable for the invention. Similar numbers in FIG. 1 and FIG. 2 are equivalent process units and pipe systems.

Flue/synthetic gas (e.g. CO₂ and H₂) (30) may be of any composition and state, but preferentially between 5 and 30° C. Flue/synthetic gas (30) may also preferentially, but not restricted to, be free of sour gasses as e.g. NOₓ, SO₂, HCl and HF, and environmentally unfriendly components as e.g. Hg. This may be obtained by any suitable method for pre-treatment of flue/synthetic gas (30).

Flue/synthetic gas (30) may be at any pressure suitable for the process. If needed the flue/synthetic gas (30) may be compressed to a given pressure in the pipe system (33) by compressor (31) and (32). Compressors (31) and (32) may be integrated in one compressor with one or more stages. Compressors (31) and (32) may be of any suitable type powered by any suitable means (e.g., electric, steam, high pressure gas (from pipe system (40)). Pipe systems (48) and (33) may be of any pipe diameter, pressure rate and material and may contain any valve, cooler (15), heat exchanger, or any other item suitable for the process.

Compressed flue/synthetic gas (33) is injected into a first liquid water phase in a tank (35) by any suitable means at mixing point (34). At mixing point (34), the compressed flue/synthetic gas (33) will be at a higher pressure than the water phase in the tank (35). Pressure of water phase in the tank (35) at injection point (34) is obtained by pump (42) and static height h₃. The water phase may be from fresh or salt water. If any conditioning of the water phase is needed, any environmentally friendly inhibitor or conditioning chemical may be added to the water phase, e.g. for inhibition of any scale formation from e.g. salt water. The tank (35) may be a high-pressure pipe system or tank, of any suitable diameter or height, made from any suitable material, situated vertically, horizontally, or tilted at any angle. Flue/synthetic gas from mixing point (34) will rise in the tank (35) due to buoyancy and leave the tank (35) into pipe system (38). Water phase in (35) may be stagnant (batch mode) or preferentially, flow counter current to the gas phase from (34). If counter current, the fluid flow rate of descending water in (35) should preferentially be lower than ascending rate of gas in (35). (35) may be open or filled with any suitable means (e.g. mesh, mixer, or any suitable gas/water contactor for optimum contact area between water and gas phases). Pressure at gas outlet (38) of (35) is at a pressure above atmospheric suitable for the process. For a flue gas system, the outlet gas pressure may be at any pressure, but preferentially in the range of 2 to 10 bara.

In the tank (35) CO₂ from flue/synthetic gas (30) will be dissolved in the water phase. Other gases such as e.g. nitrogen and oxygen in a flue gas, or e.g. hydrogen in a synthetic gas, will also to some degree be dissolved in the water phase. The amount of CO₂ dissolved in the water phase in the tank (35) is mainly given by pressure, temperature, pH in the water phase, and the ratio between water and gas phase in the tank (35).

Tank (35) may be used single or as a first unit in a series. In FIG. 2 the latter is illustrated by tanks (36) and (37). Tanks (36) and (37) may, like tank (35) be any pipe or tank system of any height, open or filled with any suitable means. The number of tanks like (35) to be used for the invention is given by the amount of CO₂ that is dissolved in the water phase for each tank. In a three tank system as shown in FIG. 2, up to nearly 100% of CO₂ in the flue or synthetic gas (30) may be dissolved in the water phase before reaching the top of tank (37).

If the tank (35) is used single, gas pressure at top of unit (35) will be at a pressure above atmospheric. The gas phase is then led though valve (41) into pipe system (40). Valve (41) may be any suitable valve. Pipe system (40) may be of any pipe diameter, pressure rate and material and may contain any valve, cooler, heat exchanger, liquid separator, or any other item suitable for the process. Gas at high pressure from pipe system (40) may then be used in compressor (31) for compression of incoming gas (30) and (11). Gas released from compressor (31) goes into pipe system (52), which is equivalent to the purpose of pipe system (5) in FIG. 1. Liquid water phase from (35) is led through pipe system (46) and choke/valve (47) to the first depressurizing unit (6). Choke/valve (47) may be of any suitable kind. Pipe system (46) may be of any pipe diameter, pressure rate and material and may contain any valve, cooler, heat exchanger, or any other item suitable for the process. From (6) onwards the water/gas systems are equal to the systems with identical numbers given in FIG. 1.

As indicated in FIG. 2, water from the first depressurizing unit (6), carrying dissolved CO₂, may optionally be partly diverted (53) from the flow in the pipe system (19) for direct use in a wide range of applications (cf. below).

A three stage (35), (36), and (37), process for dissolving CO₂ in a water phase is also illustrated in FIG. 2. Gas phase from unit (35) is led through pipe system (38) into unit (36) where more CO₂ is dissolved in the water phase in a similar process as given for unit (35). Gas phase from top of unit (36) is then led through pipe system (39) to unit (37) where more CO₂ is dissolved in the water phase in a similar process as given for unit (35). At top of unit (37) the gas is led into pipe system (49) under conditions which may range from high to near atmospheric pressure. Pipe system (49) may be of any pipe diameter, pressure rate and material and may contain any item suitable for the process. If gas pressure is high, gas from pipe system (49) may go through valve (50) to pipe system (40). At low or near atmospheric pressure the gas from pipe system (49) may go through a valve or choke (51) to pipe system (5) (equal to (5) in FIG. 1). Valve (50) and valve/choke (51) may be of any kind suited for the purpose. In a counter current stream, water is pumped from unit (37) to unit (36) against increased pressure by pipe system (45) and pump (44), and from unit (36) to unit (35) by pipe system (43) and pump (42). Pump (42) and pump (44) may be of any kind suited for the process. Pipe systems (38), (39), (43) and (45) may be of any pipe diameter, pressure rate and material and may contain any valve, cooler, heat exchanger, or any other item suitable for the process.

The present innovation may also be used for producing carbonated water by diverting a stream (53) after first depressurizing unit (6) as shown in FIGS. 1, 2, 3, and 4. The stream (53) of carbonated water may then be used further in any industrial processes for e.g. neutralisation of basic process water, added as a reagent or additive to any product as e.g. cement or ash, or any other application where carbonated water or CO2 extracted from such water may be used. One such application is to use carbonated water from stream (53) as a CO2 gas and water vapor resource in greenhouses for growing of e.g. flowers or vegetables. Burning of e.g. biogenic waste materials for heat may then be used as a flue gas source. In any application of stream (53), stream (53) may contain a part of or all water added to first depressurizing unit (6), potentially supplemented by fresh water added at stream (28).

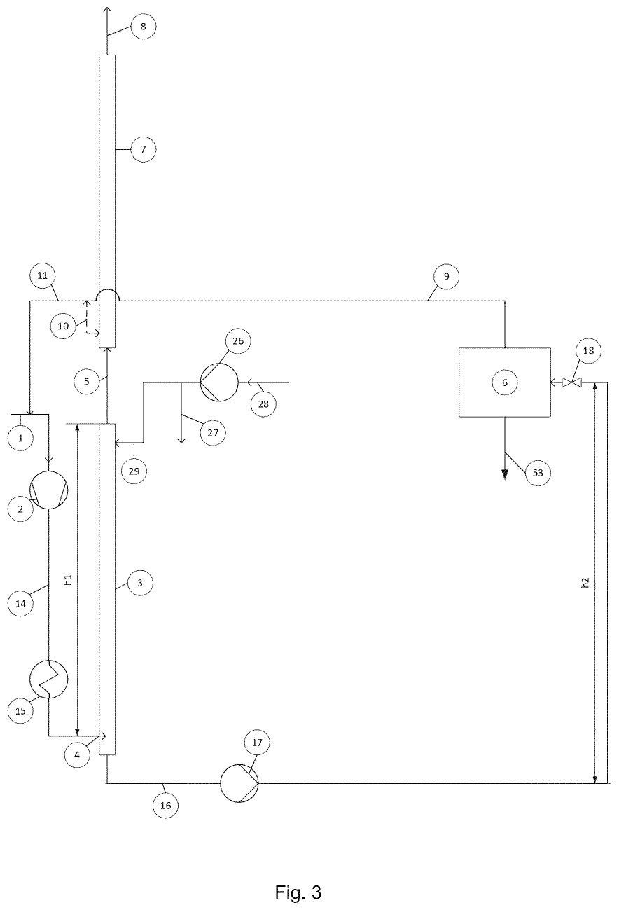

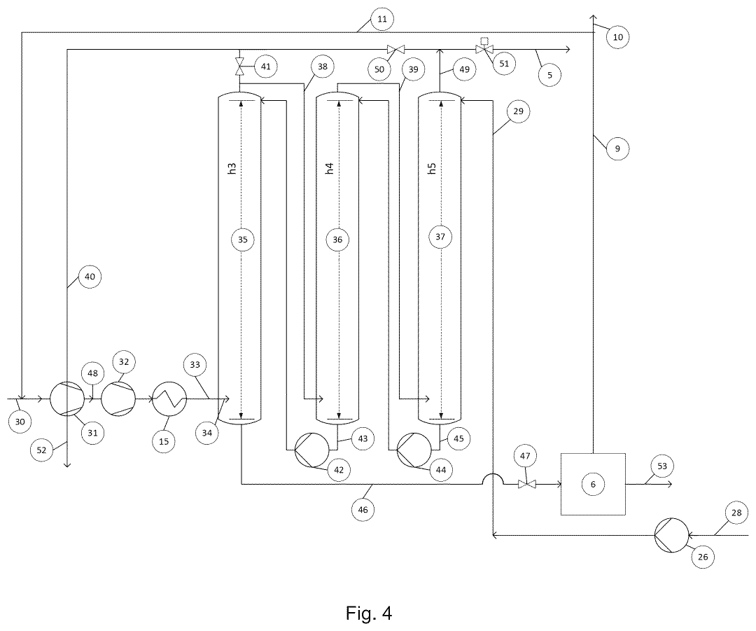

If all water to first depressurizing unit (6) is used for stream (53), a simplified version of the present innovation may be used as shown in FIGS. 3, 4. Here units (12), (20), (21) and (22) and streams (19), (23), (24) presented in FIGS. 1, 2 have been omitted. Stream (28) provides the fresh water to the process.

1. A method for capturing CO₂ from a gas mixture comprising CO₂ and one or more other gases by dissolution in a liquid water phase, where the CO₂ gas has higher solubility in the water than the one or more other gases, where the method comprises the following steps:
injecting the gas mixture as bubbles into a volume of water with a surface, allowing the gas mixture in the bubbles to interact with the water, thereby causing CO₂ gas to dissolve in the water to a higher degree than the one or more other gases, further allowing the bubbles enriched in gas not dissolved to ascend to and exit from the surface of the volume of water, resulting in the water becoming enriched in CO₂, and further allowing the CO₂ enriched water to exit out of the volume; and
performing a first step depressurizing of the CO₂ enriched water to a first pressure level thereby degassing the one or more other gases from the CO₂ enriched water to a higher degree than CO₂ giving first step depressurized water.

2. The method according to claim 1, further comprising performing a second step depressurizing of the first step depressurized water where depressurizing is to a lower pressure level than that in the first step depressurizing, thereby degassing CO₂ from the first step depressurized water giving second step depressurized water depleted in CO₂.

3. The method according to claim 1, where depressurizing is by one or more of the following: A throttling process, flashing over a valve/choke, or pumping by a vacuuming device.

4. The method according to claim 2, further comprising collecting the CO₂ degassed from the water in the second step depressurizing.

5. The method according to claim 1, comprising, prior to the injecting, at least one of i) compressing the gas mixture preferably to a minimum pressure of 3 bara and ii) cooling the gas mixture preferably to 5-30 degrees C.

6. The method according to claim 1, where the water in the water volume is counter current to the bubbles, with a water descent rate preferably lower than ascent rate of the bubbles.

7. The method according to claim 1, comprising obtaining pressure of the liquid water phase in the volume of water by at least one of the following: A static head h₁ in the volume of water and: Gas pressure acting on the surface of the volume of water.

8. The method according to claim 1, comprising using gas under pressure from pipe system (40) in compressor (31) for compression of incoming gas (30) and (11).

9. The method according to claim 1, further comprising, in a batch mode, filling the water volume with water prior to the step of injecting, keeping the water stagnant for a period when CO₂ is dissolved, and thereafter completing the step by allowing the CO₂ enriched water to exit out of the volume.

10. The method according to claim 1, where gas degassed from the water in the first step depressurizing is reinjected in the gas mixture prior to the injecting and, if applicable, the compressing according to claim 5.

11. The method according to claim 2, further comprising cooling gas and vapour degassed from the water in the second step depressurizing giving condensed water and gas enriched in CO₂.

12. The method according to claim 11, comprising reinjecting the condensed water into the first step depressurized water prior to the second step depressurizing.

13. The method according to claim 11, further comprising releasing the gas enriched in CO₂ to any further treatment.

14. The method according to one of the claims 2 to 13 claim 2, comprising injecting the second step depressurized water depleted in CO₂ into the water volume.

15. The method according to claim 1, injecting water into the water volume.

16. The method according to claim 1, where the method uses at least one following water volume, and where the method further comprises performing the step of injecting on each following volume by injecting at least part of the gas exiting from the ascending bubbles of the preceding volume, and where the CO₂ enriched water exiting from the following volume is injected in the preceding volume.

17. The method according to claim 1, where the gas mixture comprises at least one of flue gas, natural gas and synthetic gas.

18. The method according to ene of the claims above claim 1, comprising diverting at least parts of the first step depressurized water thereby producing carbonated water.

19. A system for capturing CO₂ from a gas mixture comprising CO₂ and one or more other gases by dissolution in a liquid water phase, where the CO₂ gas has higher solubility in the water than the one or more other gases, where the system is arranged for performing the method according to claim 1.

20. A system for capturing CO₂ from a gas mixture comprising CO₂ and one or more other gases by dissolution in a liquid water phase, where the CO₂ gas has higher solubility in the water than the one or more other gases, where the system comprises:
means for injecting the gas mixture as bubbles into a volume of water with a surface, allowing the gas mixture in the bubbles to interact with the water, thereby causing CO₂ gas to dissolve in the water to a higher degree than the one or more other gases, further allowing the bubbles enriched in gas not dissolved to ascend to and exit from the surface of the volume of water, resulting in the water becoming enriched in CO₂, and further allowing the CO₂ enriched water to exit out of the volume; and
means for performing a first step depressurizing of the CO₂ enriched water to a first pressure level thereby degassing the one or more other gases from the CO₂ enriched water to a higher degree than CO₂ giving first step depressurized water.

21. The system according to claim 20, further comprising means for performing a second step depressurizing of the first step enriched water where depressurizing is to a lower pressure level than that in the first step depressurizing, thereby degassing CO₂ from the first step depressurized water giving second step depressurized water depleted in CO₂.
